(19) United States
(12) Patent Application Publication
(10) Pub. No.: US 2017/0071023 A1
(43) Pub. Date: Mar. 9, 2017

(54) METHOD, USER EQUIPMENT, MASTER EVOLVED NODE B AND COMMUNICATION SYSTEM FOR DUAL CONNECTIVITY

(71) Applicant: NEC EUROPE LTD., Heidelberg (DE)

(72) Inventors: Andreas Kunz, Ladenburg (DE); Genadi Velev, Darmstadt (DE); Andreas Maeder, Wuerzburg (DE); Athul Prasad, Helsinki (FI)

(21) Appl. No.: 15/303,529

(22) PCT Filed: Mar. 16, 2015
(86) PCT No.: PCT/EP2015/055464

§ 371 Date: Oct. 12, 2016

(30) Foreign Application Priority Data
Mar. 14, 2014 (EP) 14159977.9

(51) Int. Cl. H04W 76/02; H04W 8/22; H04W 36/28

(52) U.S. Cl. CPC H04W 76/025; H04W 36/28; H04W 8/22; H04W 76/028; H04W 88/08

(57) ABSTRACT

A method for dual connectivity (DC) performed by a user equipment (UE), wherein said the UE is in connected mode and is connected to a master evolved node B (MeNB) and connectable to a secondary evolved node B (SeNB), includes informing a communication system entity about regarding DC support of said the UE, and when the UE supports DC, receiving a connection reconfiguration message to change or split bearers from the MeNB to the SeNB.

### CROSS REFERENCE TO RELATED APPLICATIONS

This application is a U.S. National Stage Application under 35 U.S.C. §371 of International Application No. PCT/EP2015/055464 filed on Mar. 16, 2015, and claims benefit to European Patent Application No. EP 14159977.9 filed on Mar. 14, 2014. The International Application was published in English on Sep. 17, 2015 as WO 2015/136122 A1 under PCT Article 21(2).

### INCORPORATION BY REFERENCE

The following non-patent literature is hereby incorporated by reference herein:
1. 3GPP TS 36.300 “Evolved Universal Terrestrial Radio Access (E-UTRA) and Evolved Universal Terrestrial Radio Access Network (E-UTRAN); Overall description; Stage 2.”
2. 3GPP TS 36.423 “Evolved Universal Terrestrial Radio Access Network (E-UTRAN); X2 Application Protocol (X2AP).”
3. 3GPP TS 36.413 “Evolved Universal Terrestrial Radio Access Network (E-UTRAN); S1 Application Protocol (S1AP).”
4. 3GPP TS 23.203 “Policy and charging control architecture.”
5. 3GPP TS 23.401 “General Packet Radio Service (GPRS) enhancements for Evolved Universal Terrestrial Radio Access Network (E-UTRAN) access.”
6. 3GPP TR 36.872 “Small cell enhancements for E-UTRA and E-UTRAN—Physical layer aspects.”
7. 3GPP TR 36.932 “Scenarios and requirements for small cell enhancements for E-UTRA and E-UTRAN.”
8. 3GPP TR 36.842 “Study on Small Cell enhancements for E-UTRA and E-UTRAN; Higher layer aspects.”

### FIELD

The present application relates to mobile communication systems and methods, and more particularly to mobile communication systems and methods that support dual connectivity of a user equipment.

### BACKGROUND

Conventional communication systems enable users not only to telephone while moving but also to stay “online,” i.e. remain connected to the Internet with their mobile phone or smart phone. For instance, users can write e-mails and send them from their smart phone while simultaneously being active on an audio/video call or a conference call.

FIG. 1 shows a part of such a conventional communication system. In FIG. 1 two alternatives for a conventional communication system architecture are shown. These alternatives are based on current 3GPP studies of the enhancement of small cells in 3GPP TR 36.872 “Small cell enhancements for E-UTRA and E-UTRAN—Physical layer aspects,” 3GPP TR 36.932 “Scenarios and requirements for small cell enhancements for E-UTRA and E-UTRAN” and 3GPP TR 36.842 “Study on Small Cell enhancements for E-UTRA and E-UTRAN; Higher layer aspects,” all of which are incorporated by reference herein.

The conclusions of said studies led to the two architecture alternatives 1A and 3C, depicted in the FIG. 1. In Alternative 1A, a Serving Gateway (SGW) is responsible for sending two different bearers over two different paths to a Master eNodeB (MeNB) and to the small cell called Secondary eNodeB (SeNB). It is possibly considered that Alternative 1A has impacts on core network (CN) procedures and functions. The bearers established via the SeNB in Alternative 1A are called small cell group bearers, i.e. ‘SCG bearers.’ The SCG bearers are routed from the SGW to the SeNB and further to the UE.

In Alternative 3C, the MeNB receives both or all bearers from the SGW and is responsible for splitting one bearer towards the SeNB. It is possibly assumed that Alternative 3C has no impact on the CN procedures and functions. The bearers established via the SeNB in Alternative 3C are called ‘split bearers.’

FIG. 2 shows a conventional scenario for dual connectivity. In FIG. 2, a basic scenario with an MeNB, an SeNB, and a UE is shown in which a User Equipment (UE) is moving around in ECM_CONNECTED mode to the small cell, i.e. the SeNB. The UE may have only a single default bearer activated or may have multiple bearers active. When the UE is connected to the MeNB, has dual connectivity capability and is within the cell coverage also of the SeNB, the UE may also connect to the SeNB, such that the UE is operating in Dual Connectivity mode, and part or all of the bearers may be switched from the MeNB to the SeNB. To switch or relocate said bearers a procedure according to FIG. 3 may be performed.

FIG. 3 shows a conventional procedure for addition/re-direction of the bearer(s). In FIG. 3, a possible procedure for addition/re-direction of the bearer(s) from the MeNB to the SeNB or SeNB bearer modification procedures are shown according to 3GPP TR 36.842. As can be seen in FIG. 3, either the MeNB or the SeNB can initiate said procedures, however the radio resource control (RRC) signaling, e.g. RRC Connection Reconfiguration to the UE, is performed only from the MeNB.

The trigger event for the bearer addition/modification procedure is currently not specified in 3GPP, as this could be based on the operator specific configuration. If a mobile UE uses dual connectivity, the bearers which are routed over the SeNB would be more frequently re-directed/modified than the bearers which are routed over the MeNB. Thus, the increased number of handovers to and from the SeNBs would impact the delay performance of the data delivery additionally to the increased control plane (C-plane) signaling. One possible problem to solve is what are the mechanisms in the radio access network (RAN), e.g. concerning the MeNB, to decide which bearers are re-directed to the SeNB cells.

A possible operator policy can be that bearer(s) to specific Access Point Name (APN) are not allowed to be re-directed over SeNB in order to assure low disruption of the UE's traffic delivery due to handovers. However, the RAN, e.g. MeNB can differentiate the bearers based only on the Quality of Service (QoS) parameters, Quality of Service Class identifier (QCI), and address resolution protocol (ARP) parameters. In other words, the MeNB cannot differentiate the UE's bearers based on APNs, default or dedicated bearer, e.g. whether two bearers belong to same APN. Therefore, one main problem is to provide a solution to enable the RAN node, e.g. the MeNB or SeNB, to apply dual connectivity control, i.e. addition and/or modification of bearers over SeNB based on the criteria such as APN to which the bearers are connected and/or whether the bearers are default or dedicated.

FIG. 4 shows a conventional procedure to release an SeNB. In FIG. 4 an SeNB release procedure according TR 36.842 is shown. Conventional handover procedures handover all available bearers to the target cell based on resources of the target, else the bearer is removed completely, instead of selectively providing a handover only of specific bearer(s) with a continuation of the remaining bearer(s) at the source cell.

Conventionally dual connectivity has been defined such that MeNB and SeNB can have multiple cells linked to it called Cell Groups (CG) R2-140906. Thus, the MeNBs and SeNBs described herein are applicable to all CGs under each eNB, denoted as Master Cell Group (MCG) for cells under an MeNB and Secondary Cell Group (SCG) for cells under an SeNB. These terms are used interchangeably throughout the context of this application, in particular in the description and in the claims.

Dual connectivity as it is envisioned conventionally, involves UEs having multiple connections with MeNB and/or MCGs as well as with SeNB and/or SCGs. SeNBs are assumed to be deployed in a different frequency layer as compared to the macro cell in order to enable an inter-eNB carrier aggregation mechanism for maximizing potential throughput available to the users. Since MeNB/MCG acts as the cell through which control plane interactions takes place, it is assumed that measurement related RRC configurations would be provided to UE by this cell. For measuring the synchronization signals of an SeNB, an MeNB either needs to provide explicit measurement gaps, where no Uplink/Downlink information is sent, or information regarding when to initiate measurements and report the measurement results. Such operations conventionally involve a significant amount of signaling as well as energy consumption at the UE, since the UE needs to switch to the different frequency layers where SeNB is deployed and then conduct said measurements.

### SUMMARY

In an embodiment, the present invention provides a method for dual connectivity (DC) performed by a user equipment (UE), wherein the UE is in connected mode and is connected to a master evolved node B (MeNB) and connectable to a secondary evolved node B (SeNB). The method includes informing a communication system entity about regarding DC support of said the UE, and when the UE supports DC, receiving a connection reconfiguration message to change or split bearers from the MeNB to the SeNB.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a part of a conventional communication system;

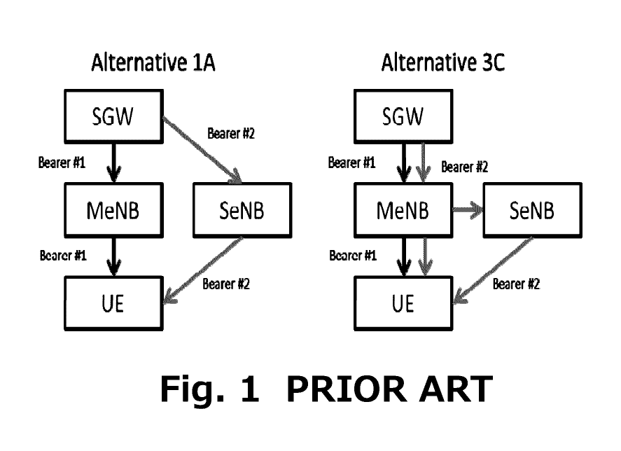

FIG. 2 shows a conventional scenario for dual connectivity;

FIG. 3 shows a conventional procedure for addition/re-direction of bearer(s);

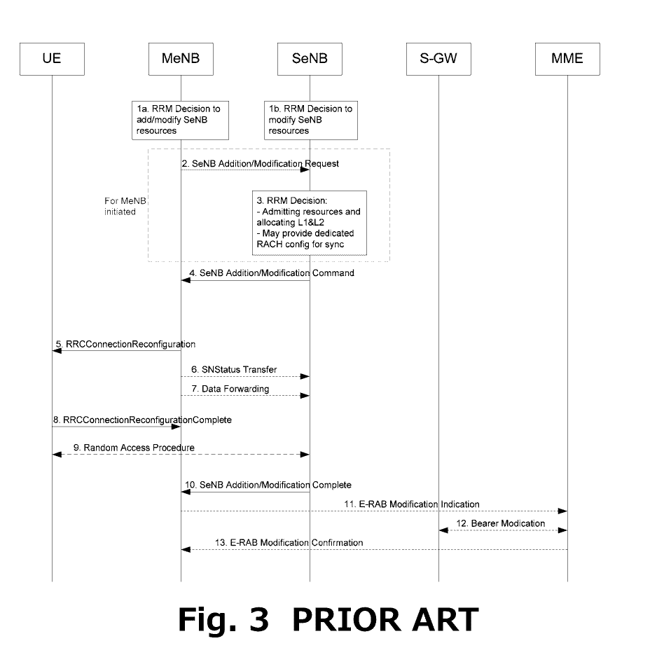

FIG. 4 shows a conventional procedure to release an SeNB;

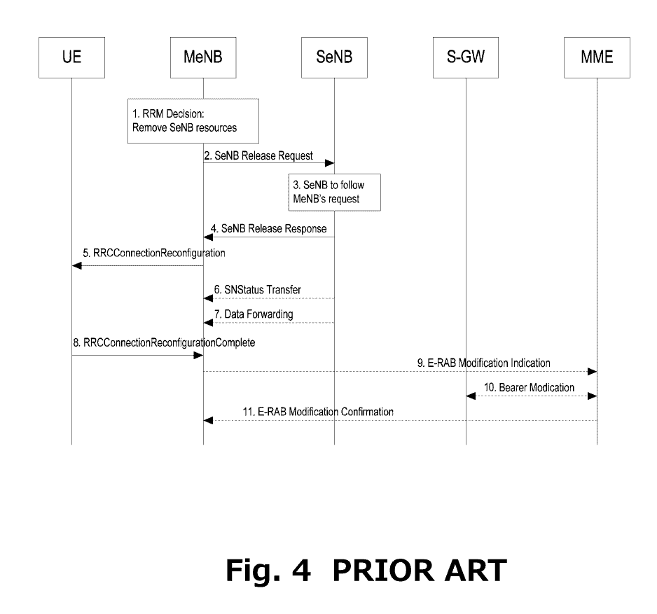

FIG. 5 shows steps of a method according to an embodiment of the invention;

FIG. 6 shows steps of a method according to a further embodiment of the invention;

FIG. 7 shows steps of a method according to a further embodiment of the invention;

FIGS. 8a and 8b show steps of a method performed on a UE and a schematical view of a UE according to a further embodiment of the invention;

FIGS. 9a and 9b show steps of a method performed on an MeNB and a schematical view of an MeNB according to a further embodiment of the invention;

FIGS. 10a and 10b show steps of a method performed on an SeNB and a schematical view of an SeNB according to a further embodiment of the invention; and

FIG. 11 shows schematically a communication system according to a further embodiment of the invention.

### DETAILED DESCRIPTION

At least one embodiment relates to a method for dual connectivity (DC) performed by a user equipment (UE), wherein said UE is in connected mode and is connected to a master evolved node B (MeNB) and connectable to a secondary evolved node B (SeNB).

At least one embodiment relates to a method for dual connectivity (DC) performed by a master evolved node B (MeNB) in a communication system including a user equipment (UE) wherein said UE is in connected mode and is connected to said MeNB and connectable to a secondary evolved node B (SeNB).

At least one embodiment relates to a method for dual connectivity, (DC) performed in a communication system including a user equipment (UE) wherein said UE is in connected mode and is connected to a master evolved node B (MeNB) and connectable to a secondary evolved node B (SeNB).

At least one embodiment relates to a user equipment (UE) wherein said UE is in connected mode and is connected to a master evolved node B (MeNB) and connectable to a secondary evolved node B (SeNB).

At least one embodiment relates to a master evolved node B (MeNB) in a communication system including a user equipment (UE) wherein said UE is in connected mode and is connected to said MeNB, and connectable to a secondary evolved node B (SeNB).

At least one embodiment relates to a communication system including a user equipment (UE) wherein said UE is in connected mode and is connected to a master evolved node B (MeNB) and connectable to a secondary evolved node B (SeNB).

Although applicable to any kind of communication system, at least one embodiment will be described with regard to mobile communication systems according to 3GPP and its technical reports (TR) and its technical specifications (TS).

Although applicable to any kind of user equipment, at least one embodiment will be described with regard to user equipment according to 3GPP and its technical reports (TR) and its technical specifications (TS).

Although applicable to any kind of base station, at least one embodiment will be described with regard to base stations, in particular in form of evolved node Bs according to 3GPP and its technical reports (TR) and its technical specifications (TS).

One of the problems is therefore to determine the mechanisms in the radio access network (RAN) e.g. concerning the MeNB, to decide which bearers are re-directed to the SeNB cells. Another problem is to enable the RAN node, e.g. the MeNB or SeNB, to apply dual connectivity control, i.e. addition/modification of bearers over SeNB. A further problem is the significant amount of signaling as well as energy consumption at the UE.

At least one embodiment of this application shows it has an advantage at least one of to enhance flexibility, to enable an easy implementation, to reduce the amount of signaling and to reduce energy consumption, in particular at the UE.

In at least one embodiment of this application a method for dual connectivity (DC) (DC) performed by a user equipment (UE) is described, wherein said UE is in connected mode and is connected to a master evolved node B (MeNB) and connectable to a secondary evolved node B (SeNB) the method comprising: informing a communication system entity about DC support of said UE, and when the UE supports DC, receiving a connection reconfiguration message to change or split bearers from the MeNB to the SeNB.

In at least one embodiment of this application a method for dual connectivity (DC) (DC) performed by a master evolved node B (MeNB) in a communication system including a user equipment (UE), is described, wherein said UE is in connected mode and is connected to said MeNB and connectable to a secondary evolved node B (SeNB) the method comprising: receiving information about DC support of said UE; and providing, to said UE, a connection reconfiguration message to change or split bearers from the MeNB to the SeNB, when said UE supports DC.

In at least one embodiment of this application a method for dual connectivity, (DC) performed in a communication system including a user equipment (UE) is described, wherein said UE is in connected mode and is connected to a master evolved node B (MeNB) and connectable to a secondary evolved node B (SeNB) the method comprising: the UE: informing a communication system entity about DC support of said UE, and when said UE supports DC, receiving a connection reconfiguration message to change or split bearers from said MeNB to said SeNB. the MeNB: receiving information about DC support of said UE; and providing, to said UE, a connection reconfiguration message to change or split bearers from said MeNB to said SeNB when said UE supports DC.

In at least one embodiment of this application a method for dual connectivity (DC) (DC) of a user equipment (UE) is described including information of a communication system entity about DC support of said UE, wherein a connection reconfiguration message to change or split bearers from a master evolved node B (MeNB) to a secondary evolved node B (SeNB) is generated by said MeNB when the UE supports DC and sent to said UE.

In at least one embodiment of this application a user equipment (UE) is described, wherein said UE is in connected mode and is connected to a master evolved node B (MeNB) and connectable to a secondary evolved node B (SeNB) the UE comprising: means for informing a communication system entity about its dual connectivity, (DC) support, and means for receiving a connection reconfiguration message to change or split bearers from said MeNB to said SeNB when said UE supports DC.

In at least one embodiment of this application a master evolved node B (MeNB) in a communication system including a user equipment (UE) is described, wherein said UE is in connected mode and is connected to said MeNB, and connectable to a secondary evolved node B (SeNB) the MeNB comprising: means for receiving information about dual connectivity, (DC) support of said UE; and means for providing, to said UE, a connection reconfiguration message to change or split bearers from said MeNB to said SeNB, when said UE supports DC.

In at least one embodiment a communication system including a user equipment (UE) is described, wherein said UE is in connected mode and is connected to a master evolved node B (MeNB) and connectable to a secondary evolved node B (SeNB) the communication system including the UE which includes means for informing a communication system entity about its dual connectivity (DC) support and means for receiving a connection reconfiguration message to change or split bearers from said MeNB to said SeNB when said UE supports DC. The MeNB includes means for receiving information about DC support of said UE and means for providing, to said UE, a connection reconfiguration message to change or split bearers from said MeNB to said SeNB, when said UE supports DC.

Said connection reconfiguration message may comprise a new radio resource configuration for DC with the SeNB. Said communication system entity may be either the MeNB or a mobility management entity (MME). Said MeNB may decide to configure said UE for DC. Said decision may be based on properties of current bearers of said UE. Said connection reconfiguration message may comprise a new radio resource configuration for DC of said UE with said SeNB. Said MeNB may decide to configure said UE for DC. Said decision may be based on properties of current bearers of said UE. Said connection reconfiguration message may comprise a new radio resource configuration for DC of said UE with said SeNB.

The SeNB can receive bearer relocation information of said UE for changing or splitting bearers from said MeNB to said SeNB when said UE supports DC, allocate radio resources for said bearers on said SeNB if available, and receive said bearers from said MeNB. Said connection reconfiguration message may be generated based on properties of current bearers of said UE. Said MeNB may include in said connection reconfiguration message a new radio resource configuration for said UE for DC of said UE with said SeNB. The information about DC support may be sent directly to said further communication system entity by said UE or via said MeNB. Said further communication system entity may be provided in form of a mobility management entity (MME). Said MeNB may maintain bearer relocation information of bearers of said UE for relocation to said SeNB. Said bearer relocation information may be configured on said MeNB during a S1-MME procedure.

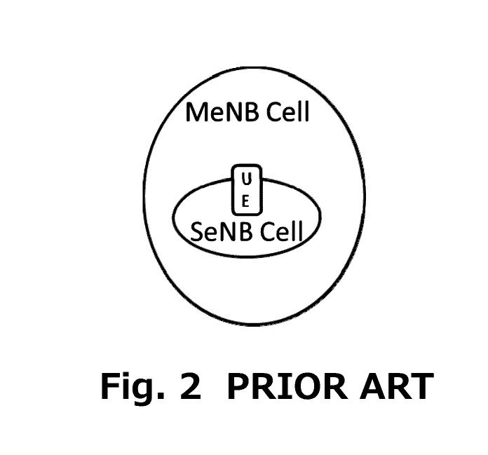

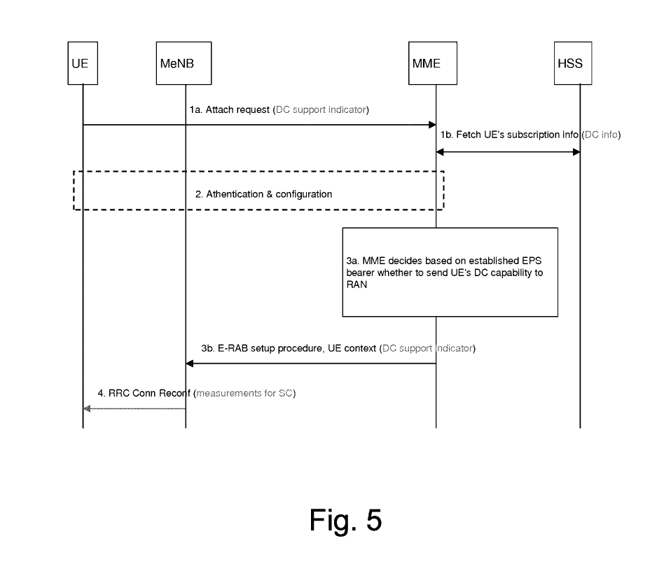

FIG. 5 shows steps of a method according to an embodiment of the invention. In the following the scenario of FIG. 2 is assumed that the UE is in ECM_CONNECTED Mode, the UE has one or more active bearers, the UE is connected to the MeNB, the SeNB is within coverage of the MeNB, the SeNB and the MeNB are connected to the same (pool of) Serving Gateways (SGW), and possibly that the UE is moving around within the coverage of the MeNB and enters the SeNB cell or is already within the SeNB cell.

The dual connectivity (DC), i.e. support of simultaneous macro cell and small cell connectivity, is a feature which may or may not be supported by the UE and the communication network. As it is assumed that the communication network including both RAN or CN initiates establishment of the dual connectivity, i.e. the connection to a small cell, it is crucial to have information about the UE capabilities related to the dual connectivity.

In FIG. 5 the UE exchanges dual connectivity capabilities with the network, i.e. RAN/eNB or CN/MME, wherein the (MME) refers to a mobility management entity during the attach procedure of said UE. Then the network, the RAN and/or the CN stores the UE capabilities, including the DC capability in a corresponding UE's context.

The exchange of UE capabilities related to dual connectivity DC can be performed during said Attach procedure, during a Routing Area Update (RAU)/Tracking Area Update (TAU) procedure, or any other kind of non-access stratum (NAS) exchange between the UE and MME. Further, the DC capabilities can be stored in a home subscriber server (HSS)/home location server (HLR), and can be signaled to the mobility management entity (MME)/Serving GPRS Support Node (SGSN) during the Attach procedure.

One possible use of the UE's capability for DC is described herewith. The (M)eNB can configure the UE for radio measurements in the small cell(s) frequencies depending of the UE's support of DC. If the UE does not support dual connectivity DC, then the (M)eNB does not configure the UE for measurements in the frequency spectrum where small cells controlled by SeNB operate. In contrast, if the UE supports dual connectivity, then the (M)eNB can configure the UE for radio measurements in the frequency resources of the small cells.

An exchange of capabilities for dual connectivity and configuration of the UE is shown in FIG. 5. The steps from FIG. 5 are described as follows. In Step (1), the UE performs an Attach procedure. Additionally to the existing parameters or Informational Elements in the NAS Attach request message, the UE includes an indication/Informational Element for dual connectivity, being indicated as DC info indicator in FIG. 5 support capability. The serving node, the MME or SGSN, etc. stores the UE capability, e.g. in the UE's context in the serving node. The serving node, e.g. MME or SGSN,—however only MME is used further here—can fetch the UE's subscription information from HSS/HLR. Optionally the UE's context stored in the HSS/HLR may contain the UE's DC support capability. Thus, the MME can learn about the UE's DC support capability from the UE's context stored in the HSS/HLR. Furthermore the serving node, e.g. MME, SGSN, etc., can be configured by the mobile operator with a DC policy which is taken into account in addition to the UE capability as described in step (3). In summary, within step (1), the MME learns about UE's DC capability either from the UE or from the subscription information or from both.

In step (2), authentication and configuration as well as additional Core Network (CN) procedures for user plane connectivity establishment are performed.

In step (3), signaling exchange from the MME to the (M)eNB is performed. This step shows the procedure where the serving node, e.g. MME or SGSN, sends and/or configures the UE's context in the RAN node over the S1-MME or Iu interface. This step can be performed during the Attach, a Service Request or a TAU/RAU procedure with Active flag. The MME decides whether to include the UE's DC support capability indicator in the UE's context which is signaled to the RAN, e.g. the eNB. For this decision the MME may consider the UE's established/available, e.g. current EPS bearers. For example the bearers to some APN may be allowed to be re-directed, e.g. if the UE has IMS-related bearer(s) only and the network policy is not to re-direct IMS-related bearers to the small cells, the small cells controlled by the SeNB, then the MME may decide to not signal the UE DC support capability indicator to the RAN, e.g. the eNB. Another example is that the network, i.e. the public land mobile network, ‘PLMN’, may have a DC policy for using small cell redirection depending on whether the UE is roaming or non-roaming. For example roaming UEs may not be allowed to use small cells even if the UE is DC capable. On the other hand, if one or more of the established or requested bearers are allowed for small cell (SC) re-direction, then the MME may include the UE's DC support capability indicator in the UE's context to eNB. If none of the established UE's bearers are allowed for small cell re-direction, then the MME does not send the DC support capability indicator to eNB. The configuration of the MME with the DC policy can be performed by O&M procedures, i.e. operation and maintenance procedures, or other automatic or static configuration.

The sending of the UE's DC support capability indicator to eNB in Step 3b can be performed over the S1-MME interface using S1-AP protocol, but also other interfaces and protocols for the configuration and information exchange with the eNB can be used. Example messages that can be extend to convey the DC Support Indicator can be the S1-AP INITIAL CONTEXT SETUP REQUEST message, the S1-AP E-RAB SETUP REQUEST or any other suitable message sent from the MME to the eNB.

In general, any other procedure, e.g. E-RAB Management procedure or Context Management procedures or other Management procedures between the MME and eNB, can be used to configure the eNB with the appropriate settings for the dual connectivity. For example, the Management procedures S1 SETUP REQUEST and S1 SETUP RESPONSE messages can be used, or any other management procedure.

In step (4), the RAN node, e.g. the eNB performs RRC connection (re-) configuration procedure with the UE. If the UE's DC support capability is indicated in the UE's context, then the eNB configures the UE for correspondent radio measurements in the frequencies where the expected small cell(s) operate. Further eNB uses the UE's DC support capability indicator to decide whether to re-direct some of the UE's bearers to a small cell if the UE's radio measurements indicate that the UE in sufficient coverage quality of a small cell. In other words, the configuration of UE's DC support capability indicator in the MeNB can be used as admission control to the MeNB to decide whether to initiate bearer switch/relocation to small cell.

The parameters in the brackets of the signaling messages in FIG. 5 highlight the needed extensions to existing conventional protocols.

Another possible option which is not depicted in FIG. 5 is to use the Routing Area Update/Tracking Area Update RAU/TAU procedure instead of the Attach procedure for the exchange of capabilities between the UE and serving node, e.g. MME. In general, any NAS mobility management procedure can be used for the exchange of DC capabilities between UE and CN.

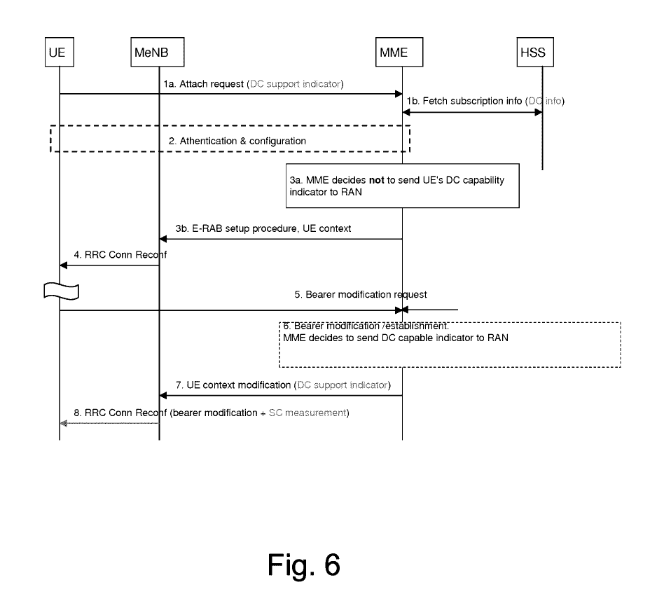

FIG. 6 shows steps of a method according to a further embodiment of this application. In yet another embodiment of this application, the MME may update the UE's context in the (M)eNB at the time point when an EPS bearer, an evolved packet system bearer, is established or modified which is able to be re-directed and/or offloaded over a small cell. This procedure is shown in FIG. 6, whose steps are described as follows.

Steps 1-4 of FIG. 6 are similar to steps 1-4 of FIG. 5, however the UE's DC support capability is not signaled to the RAN, and correspondingly the UE is not configured with radio measurements for small cells resources.

In step 5, the UE initiates a resource modification procedure which may result in a bearer modification or bearer establishment procedure from the network, e.g. a packet data network gateway (PGW) or a gateway GPRS support node (GGSN). Alternatively the network initiates a bearer modification procedure or bearer establishment procedure for new mobile terminated communication.

In step 6, the MME can detect that the MME has stored in the UE's context that the UE is DC capable, but has not signaled this capability to the RAN node, e.g. the eNB. Additionally the MME determines that the modified bearer or the new established bearer is liable for re-direction over a small cell. Therefore as part of the bearer modification procedure or update or establishment procedure the MME indicates to the RAN node the UE's DC support capability. The logic in the MME to decide to signal or not the UE's DC support capability to the RAN node is based on the characteristics of the modified/established bearer, e.g. bearers QCI, delay, belonging to APN, local-break-out or home routed traffic, or others.

In step 7, the MME signals in the UE context update/modification procedure additionally the UE's DC support capability.

In step 8, based on the updated/modified UE's context, the RAN node, e.g. the MeNB, performs RRC connection (re-)configuration procedure. If the UE's DC support capability is indicated in the UE's updated/modified context, then the eNB configures the UE for correspondent radio measurements where the expected small cell(s) operate.

The parameters in the brackets of the signaling messages in FIG. 6 show the needed extensions to existing protocols. In the above embodiment, the UE reports its DC capability to the CN, e.g. the MME, and the MME evaluates the need to configure the MeNB with DC activation for the given UE.

In contrast, another alternative embodiment is described herewith, namely the UE signals its DC capability to the MeNB directly, e.g. within RRC signaling messages, and not to the MME within NAS signaling messages. The MME can be configured by a mobile operator's DC policy in order to advice the MeNB on which bearer to relocate, if any. The DC policy is provided to the MeNB e.g. within S1-AP signaling messages, but any other suitable messages are possible e.g. via O&M provisioning. The MeNB evaluates the UE's DC capability and the mobile operator's DC policy and decides: (1) whether to configure the UE for small cell radio measurements reporting, and (2) whether or not to relocate bearers from macro to small cell based on the DC policy to the SeNB and the SeNB status.

Further in this alternative embodiment, the eNB can forward the UE's DC capability to the MME. For example the eNB can use the UE Capability Info Indication procedure including extensions to UE CAPABILITY INFO INDICATION message to signal the UE's DC capability to MME. Then the MME can use the UE's DC capability info for further actions, e.g. such explained already in the FIGS. 5 and 6.

In the following MME-assisted configuration for particular bearer redirection to SeNB is described. While in the previous aspect of this application is related to configuration related to UE's DC support capability, in the following aspect or embodiment respectively of this application, a more fine configuration granularity is proposed, namely configuration based on per bearer basis. The RAN node, e.g. the MeNB needs to decide which bearers can be switched and/or re-directed to the small cell, i.e. the SeNB after the UE's radio measurements indicated that the UE under sufficient small cell coverage.

The MeNB should be able to decide which UE's EPS bearers to switch and/or re-direct bearers to the SeNB. One option is that the decision is based on operator's policy for given type of bearer, e.g. bearer(s) with QCI 8 can be switched and/or redirected to SeNB. The MeNB can be (pre-)configured by the MME or operations, administration and management, ‘OAM’, system with general information for all UEs and all bearers. For instance, all QCI=8 bearers or bearers with no delay restriction or with less delay restrictions to be redirected to the SeNB.

However, if the decision criteria is the APN or bearer type, e.g. default or dedicated or traffic route of the bearer, e.g. home-routed or LBO, then the MeNB cannot take a decision as the MeNB does not know and cannot derive such bearer information. Therefore this embodiment provides a solution to this problem.

For example, the operator's policy can be that only bearers to a specific Access Point Name APN are allowed to be re-directed to small cells and other bearers does not. Another criterion for decision for bearer re-direction can be the type of the bearer, e.g. whether the bearer is default or dedicated bearer, or whether the bearer is a guaranteed bitrate, ‘GBR’ or non-GBR bearer, or whether the bearer traffic is home-routed or local-break-out, ‘LBO’ is applied. A roaming UE may have one packet data network ‘PDN’ connection to which LBO is applied and another PDN connection which is home-routed. One problem is that the RAN node, e.g. the MeNB does not know the relation of the established bearers to e.g. APNs and whether the bearers are default or dedicated, or whether the bearers are LBO-routed or home-routed.

Therefore another embodiment of this application proposes to overcome said problem, i.e. the MeNB maintains information in the UE's bearer context which bearers are allowed to be re-directed to SeNB and which not. This information can be configured by the MME during a S1-MME procedure, e.g. bearer setup or bearer modification procedure. For example the MME can indicate to MeNB over the corresponding S1-AP protocol that the bearer under establishment/modification is “allowed” or “not allowed” for re-direction over a SeNB. This can be characterized or termed as “bearer marking” for small cell offload. In other words, the UE's context comprises EPS bearer(s) context where the bearer are marked with “allowed” or “not-allowed” for re-direction over small cell.

Another embodiment is that the MME configures the MeNB with general information which bearer(s) are allowed to be re-directed to small cells. For example, bearers with QCI “1” should not be re-directed to small cells, whereas bearers with QCI “8” are allowed for small cell offload. This is a kind of general configuration of the eNB by the network, e.g. by the MME and can be performed over S1-AP protocol or by other network management protocols.

The static configuration may apply to all UEs in the same way and the MeNBs may be pre-configured by the MME or OAM system.

The two embodiments described above, i.e. 1^{st} embodiment about UE's DC support capability, i.e. signaled in the UE's context as described in FIGS. 5 and 6, and the 2^{nd} embodiment about the EPS bearer marking for SC re-direction, can be combined together. In other words, in the same UE's context modification or update or establishment procedure the MME can indicate to eNB the UE's DC support and the bearer marking for allowed re-direction to small cell.

The embodiments described above require enhancement of the S1-AP protocol to allow the transport of indication/information how the RAN should configure the UE, e.g. for radio measurements and how to treat an established/modified bearer with respect to re-direction over a SeNB.

The serving node, e.g. the MME or the SGSN, has means to decide how to mark the bearers in the UE's context which are allowed or not allowed for redirection to small cells. This means can include the ability in the MME to be configured using network O&M procedures or other automatic or static configuration in the MME. Further, the MME may use any mixture of information from the network's policy and from the UE's subscription, e.g. gold/silver/bronze user, Home PLNM ‘HPLMN’ policy, non-3GPP access capability, etc. to take a decision for the switch/redirection of specific UE's bearer(s) to small cells.

In the following possible modifications of the network nodes involved in the embodiments of this application are described. The following modifications to a serving node, e.g. MME and/or SGSN may be needed. The ability to receive and store information about the UE capability and/or configuration for particular bearers. This information may be a subscription information received from HSS/HLR; or this information may be a configuration information from the O&M entity; or this information may be a capability information received from the UE; or this information may be received from eNB or other RAN or CN network entities. The ability to process this information for each UE and/or for each UE's bearer individually. The ability to decide whether a DC capability for a DC-capable UE should be activated and used, and if yes, then instructs the eNB correspondingly. The ability to signal the result of the processing to a RAN node, e.g. eNB, MeNB, NB, MNB.

The following modifications to a RAN node, e.g. eNB, MeNB, NB, MNB, may be needed. The ability to receive and store information about the UE capability and/or configuration for particular bearers. This information may be sent from the MME. The ability to process this information received from the serving node. The ability to send configuration signaling to UE and other RAN node, e.g. SeNB in order to inform the result of the information processing. As mentioned in the alternative embodiment, the eNB can be able to receive the DC capability from a UE, to process this information and signal it further to MME. The processing may include evaluation based on pre-provisioned DC configuration information whether a DC-capable UE should activate and use the DC capability.

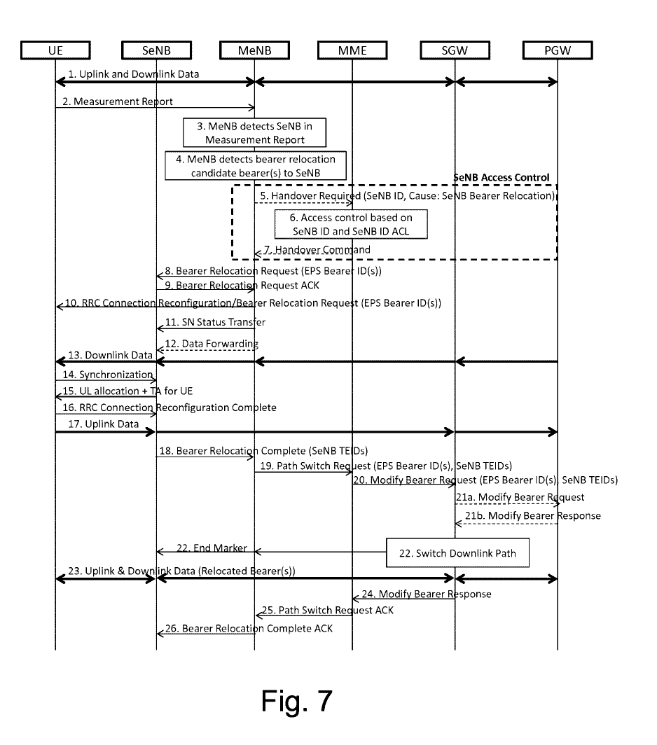

FIG. 7 shows steps of a method according to a further embodiment of this application. In FIG. 7 steps for MME-assisted bearer relocation to an SeNB are shown: The following embodiment describes an alternative solution for the admission control for the relocation of given bearers from MeNB to SeNB. In contrary to the embodiment describe above where the MME configures the bearer(s) for relocation in the UE's eNB context or general configuration, e.g. per QCI, this embodiment here describes a dynamic solution where the admission for bearer relocation is done according to the current situation. The solution is based on MME-assisted decision done per bearer relocation procedure. FIG. 7 describes the envisioned procedure to enable handover and/or relocation of selective bearer(s) to the SeNB from the MeNB based on the X2 handover procedure described in 3GPP TS 23.401 and 3GPP TS 36.300.

In step 1, the UE is in ECM_CONNECTED mode with one or more bearers active and has an ongoing data session(s) via MeNB, SGW and PGW to the packet data network, e.g. internet. The MeNB configured the UE measurement procedures according to the roaming and access restriction information.

In step 2, A MEASUREMENT REPORT is triggered in the UE and sent to the eNB.

In step 3, the MeNB detects the SeNB presence in the measurement report.

In step 4, the MeNB detects the candidate bearer(s) for bearer relocation to the SeNB. The detection could be based on QoS information such as QCI, GBR, maximum bit rate, ‘MBR’, aggregate maximum bit rate, ‘AMBR’ etc. or other information or static rules. The MeNB may request the resource status of the SeNB, e.g. by sending a Resource Status Request to the SeNB.

In step 5, for access control, the MeNB may send a Bearer Relocation Control Request, e.g. S1-AP Handover Required, Direct Forwarding Path Availability, Source to Target transparent container, target eNodeB Identity, closed subscriber group, ‘CSG’ ID, CSG access mode, target tracking area identity, ‘TAI’, and/or S1AP Cause, to the MME, with S1AP cause IE including “SeNB relocation request” in the Radio Network Layer Cause. The target eNodeB Identity is set to the Identity of the SeNB.

In step 6, the MME performs UE access control to the SeNB based on the SeNB Identity received in the Handover Required message. Access control may be based on: (a) an SeNB access control list (ACL), including a list of SeNB Identities or SeNB Group Identities. The access control list is either interpreted as whitelist, in which case access is only granted if the SeNB Identity is included in the list, or as a blacklist, in which case access is reject if the SeNB Identity is included in the list. The interpretation of the list is controlled by a corresponding flag in the MME information storage. The access control may be further based on (b) information exchange with HSS over S6a interface, requesting access control status as described in Step 6a, and (c) subscription profile based per UE, e.g. a flag.

In step 7, the source MME sends a Bearer Relocation Acknowledge, e.g. Handover Command, Target to Source transparent container, Bearers subject to forwarding, and/or Bearers to Release message to the MeNB. The Bearers subject for relocation includes a list of addresses and Tunnel Endpoint Identifiers (TEID) allocated for relocation. The Bearers to Release includes the list of bearers to be released. If the access control procedure in Step 6 fails, the MME ends the handover procedure by replying with the Handover Preparation Failure message.

In step 8, the MeNB sends a Bearer Relocation Request message with the necessary information to the SeNB to prepare the relocation, e.g. UE X2 signalling context reference at MeNB, UE S1 EPC signalling context reference, target cell ID, KeNB*, RRC context including the Cell Radio Network Temporary Identity, ‘C-RNTI’ of the UE in the MeNB, AS-configuration, EUTRAN Radio access bearers, ‘E-RAB’, context and physical layer ID of the source cell+short Message Authentication Code I, ‘MAC-I’ for possible Radio Link Failure, ‘RLF’ recovery and potentially the EPS bearer ID(s). UE X2 and/or UE S1 signalling references enable the SeNB to address the MeNB and the EPC. The E-RAB context includes necessary radio network layer, ‘RNL’ and transport network layer, ‘TNL’, addressing information, and QoS profiles of the E-RABs. This message could be also a modified HANDOVER REQUEST, e.g. S1-AP, X2-AP or any other suitable message.

In step 9, Admission Control may be performed by the SeNB dependent on the received E-RAB QoS information to increase the likelihood of a successful handover, ‘HO’, if the resources can be granted by SeNB. The SeNB configures the required resources according to the received E-RAB QoS information and reserves a C-RNTI and optionally a random access channel, ‘RACH’, preamble. The AS-configuration to be used in the target cell can either be specified independently, i.e. an “establishment” or as a delta compared to the AS-configuration used in the source cell, i.e. a “reconfiguration”. As soon as the MeNB receives the Bearer Relocation Request Acknowledge, or as soon as the transmission of the handover command is initiated in the downlink, data forwarding may be initiated, which is shown in step 9.

In step 10, the SeNB generates the RRC message to perform the handover, i.e. RRCConnectionReconfiguration message including the mobilityControlInformation, to be sent by the MeNB towards the UE. The MeNB performs the necessary integrity protection and ciphering of the message. The UE receives the RRCConnectionReconfiguration message with necessary parameters, i.e. new C-RNTI, SeNB security algorithm identifiers, and optionally dedicated RACH preamble, SeNB Service Independent Building Blocks, ‘SIBs’, etc. and is commanded by the MeNB to perform the HO. The UE does not need to delay the handover execution for delivering the Hybrid Automatic Repeat Request, ‘HARQ’, and/or Automatic Repeat Request, ‘ARQ’, responses to MeNB.

In step 11, the MeNB, the serving node, ‘SN’, sends the SN STATUS TRANSFER message to the SeNB to convey the uplink Packet Data Convergence Protocol, ‘PDCP’ SN receiver status and the downlink PDCP SN transmitter status of E-RABs for which PDCP status preservation applies, i.e. for RLC AM. The uplink PDCP SN receiver status includes at least the PDCP SN of the first missing Uplink Service Data Unit, ‘UL SDU’, and may include a bit map of the receive status of the out of sequence UL SDUs that the UE needs to retransmit in the target cell, if there are any such SDUs. The downlink PDCP SN transmitter status indicates the next PDCP SN that the SeNB shall assign to new SDUs, not having a PDCP SN yet. The MeNB may omit sending this message if none of the E-RABs of the UE shall be treated with PDCP status preservation.

In step 12, the MeNB initiates downlink data forwarding to the SeNB. This step may occur earlier.

In step 13, the downlink data is sent from the PGW to the SGW to the MeNB and then forwarded to the SeNB to the UE.

In step 14, after receiving the RRCConnectionReconfiguration message including the mobilityControlInformation, UE performs synchronisation to SeNB and accesses the target cell via RACH, following a contention-free procedure if a dedicated RACH preamble was indicated in the mobilityControlInformation, or following a contention-based procedure if no dedicated preamble was indicated. UE derives SeNB specific keys and configures the selected security algorithms to be used in the target cell.

In step 15, the SeNB responds with UL allocation and timing advance.

In step 16, when the UE has successfully accessed the target cell, the UE sends the RRCConnectionReconfigurationComplete message, C-RNTI to confirm the handover, along with an uplink Buffer Status Report, whenever possible, to the SeNB to indicate that the handover procedure is completed for the UE. The SeNB verifies the C-RNTI sent in the RRCConnectionReconfigurationComplete message. The SeNB can now begin sending data to the UE.

In step 17, the UE can start sending uplink data to the SeNB to the SGW to the PGW.

In step 18, the SeNB sends a Relocation Complete message to MeNB to inform that the UE has changed cell. The SeNB includes its Downlink, ‘DL’ TEID(s) as well as its IP Address so that the SGW can map downlink data directly to the SeNB later.

In step 19, the MeNB sends a PATH SWITCH REQUEST message to MME to inform that the UE has changed cell. The message includes the SeNB IP Address, DL TEID(s) and EPS bearer ID(s) that are relocated.

In step 20, the MME sends a MODIFY BEARER REQUEST message to the Serving Gateway including the SeNB IP Address, DL TEID(s) and EPS bearer ID(s) that are relocated. The MME may perform admission control for the bearer relocation.

In step 21, the SGW may send a Modify Bearer Request to the PGW, e.g. in case it received the User Location Information IE.

In step 22, the Serving Gateway switches the downlink data path to the SeNB for the selected EPS bearer(s). The Serving gateway sends one or more “end marker” packets on the old path to the MeNB and then can release any U-plane/TNL resources towards the MeNB for the relocated bearer(s).

In step 23, Uplink and Downlink packets of the relocated bearer(s) are transmitted now directly between SeNB and SGW using the newly received address and TEIDs.

In step 24, the Serving Gateway sends a MODIFY BEARER RESPONSE message to the MME.

In step 25, the MME confirms the PATH SWITCH REQUEST message with the PATH SWITCH REQUEST ACKNOWLEDGE message. Upon reception of the PATH SWITCH REQUEST ACKNOWLEDGE message, the MeNB can release radio and C-plane related resources associated to the UE context. Any ongoing data forwarding may continue.

In step 26, the MeNB sends a Relocation Complete Acknowledgement message to the SeNB to inform that the relocation is completed.

In the following an embodiment of this application being UE-centric for bearer redirection to SeNB is described. This further or alternative embodiment is to configure the UE with bearer information related to the admission for bearer switch/redirection to the SeNB. The UE can be instructed by the serving node, e.g. MME, SGSN during any NAS procedure, e.g. NAS session management procedure like EPS bearer establishment/modification procedures, which bearers are “allowed” or “not allowed” for redirection over the small cell. Then the UE can inform the MeNB over RRC signaling about the corresponding bearer configuration related to the admission for bearer switch/redirection to the SeNB. In this way the MeNB is able to decide whether to initiate or not the bearer switch/redirection procedure to the SeNB.

One further preferred embodiment and/or an optimization can be that the UE informs the MeNB about the bearer configuration related to the small cell redirection after the UE detects coverage of small cell. For example the UE indicates the bearer ID(s), which potentially can be relocated, during the RRC measurement report sent to the MeNB if the UE detects sufficient signal strength from a small cell.

An even further embodiment, which is described in the following, is directed to UE Inter-Frequency Measurement. This embodiment is described herewith related to the configuration of the UE with inter-frequency measurements. Inter-frequency measurements conducted by the UE based on network assistance for initiating measurements could be controlled based on this application. The decision for not initiating measurements could be initiated by MeNB based on bearer offloading configurations as mentioned in this application. Alternately, the related information could be sent to the UE as well, if the measurements are conducted by the UE autonomously. This could be applicable if the UE supports Dual Connectivity as well as carrier aggregation. Since dual connectivity deployments are different from conventional homogeneous macro-only network deployment, this could lead to significant UE power savings, by conducting measurements only when required. Under normal conditions, if SeNBs are densely deployed, it could be that UEs have to conduct inter-frequency measurements frequently in order to detect a potential SeNB, which could be avoided based on bearer offloading criteria that are pre-configured.

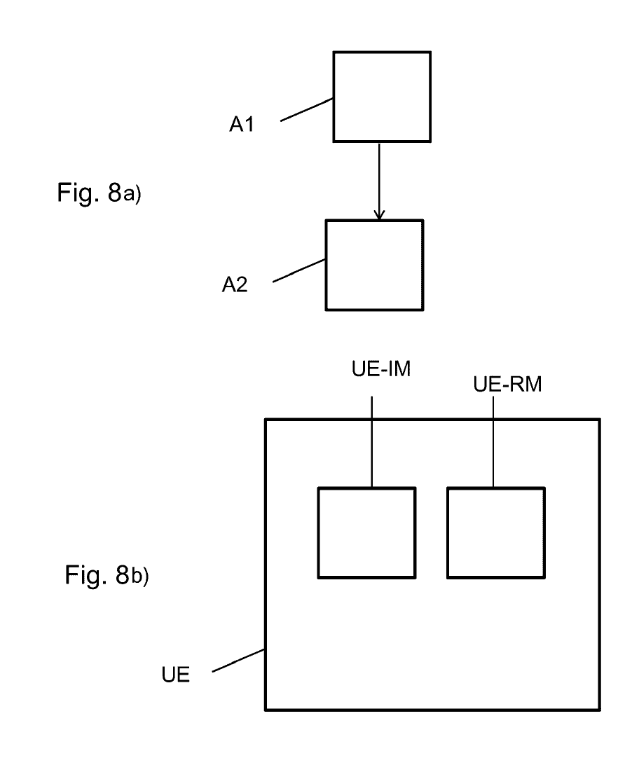

FIG. 8a shows steps of a method performed on a UE, and FIG. 8b shows a schematical view of a UE according to a further embodiment of this application.

In FIG. 8a, steps of a method for dual connectivity (DC) performed by a user equipment, UE, are shown, wherein said UE is in connected mode and is connected to a master evolved node B (MeNB) and connectable to a secondary evolved node B (SeNB), and wherein the method comprises the following steps: In step A1, informing a communication system entity about DC support of said UE, and In step A2, when the UE supports DC, receiving a connection reconfiguration message to change or split bearers from the MeNB to the SeNB.

In FIG. 8b a UE is shown comprising means UE-IM for informing a communication system entity about DC support of said UE, e.g. a sender, and means UE-RM for receiving a connection reconfiguration message to change or split bearers from the MeNB to the SeNB, when the UE supports DC, e.g. a receiver.

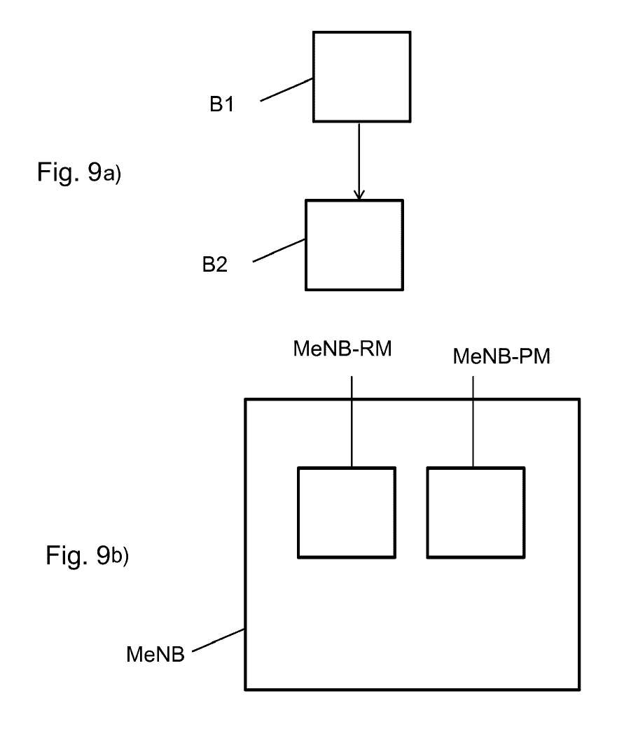

FIG. 9a shows steps of a method performed on a MeNB and FIG. 9b shows a schematical view of a MeNB according to a further embodiment of this application. In FIG. 9a steps of a method for dual connectivity (DC) performed by a master evolved node B (MeNB), in a communication system including a user equipment (UE) are shown, wherein said UE is in connected mode and is connected to said MeNB and connectable to a secondary evolved node B (SeNB) and wherein the method comprises the following steps: In step B1 receiving information about DC support of said UE; and in step B2, providing, to said UE, a connection reconfiguration message to change or split bearers from the MeNB to the SeNB, when said UE supports DC.

In FIG. 9b an MeNB is shown comprising means MeNB-RM for receiving information about DC support of said UE, e.g. a receiver, and means MeNB-PM for providing, to said UE, a connection reconfiguration message to change or split bearers from the MeNB to the SeNB, when said UE supports DC, e.g. a sender.

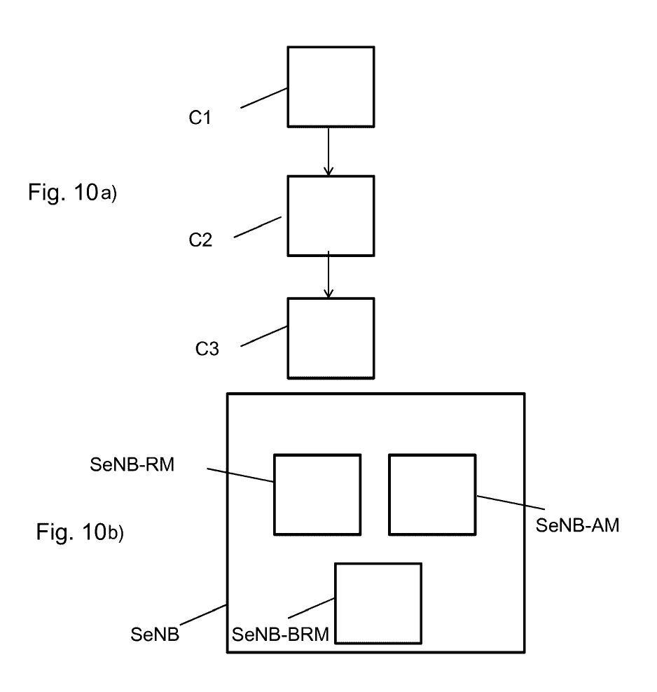

FIG. 10a shows steps of a method performed on a SeNB and FIG. 10b shows a schematical view of a SeNB according to a further embodiment of this application. In FIG. 10a steps of a method for dual connectivity (DC) (DC) performed by a secondary evolved node B (SeNB) in a communication system including a user equipment (UE) are shown, wherein said UE is in connected mode and is connected to said MeNB and connectable to said SeNB, and wherein the method comprises the following steps. In step C1, receiving bearer relocation information of said UE for changing or splitting bearers from said MeNB to said SeNB when said UE supports DC. In step C2 allocating radio resources for said bearers on said SeNB if available, and in step C3, receiving said bearers from said MeNB.

In FIG. 10b an SeNB is shown comprising means SeNB-RM for receiving bearer relocation information of said UE for changing or splitting bearers from said MeNB to said SeNB when said UE supports DC; means SeNB-AM for allocating radio resources for said bearers on said SeNB if available; and means SeNB-BRM for receiving said bearers from said MeNB.

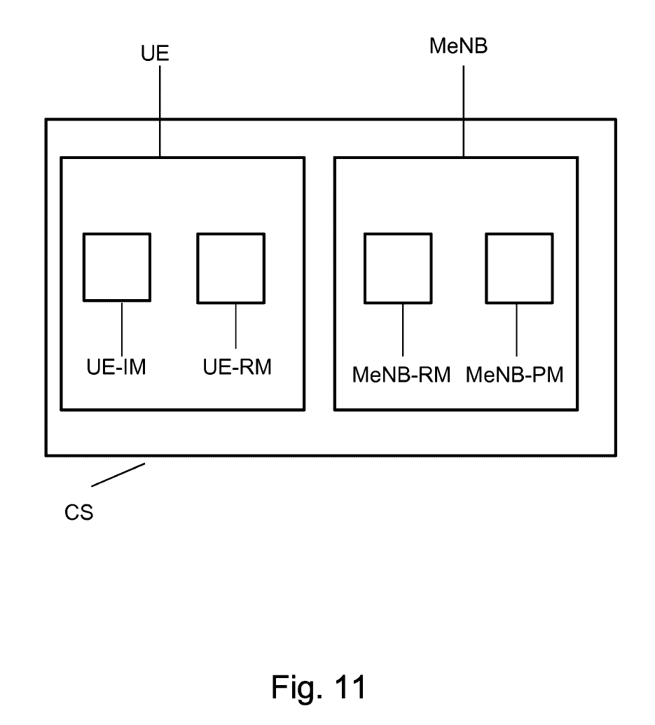

FIG. 11 shows schematically a communication system according to a further embodiment of this application. In FIG. 11 a communication system CS is shown, comprising a user equipment UE and a master evolved node B MeNB. The user equipment UE comprises means UE-IM for informing a communication system entity about DC support of said UE, e.g. in form of a sender correspondingly adapted, and means UE-RM for receiving a connection reconfiguration message to change or split bearers from the MeNB to the SeNB, when the UE supports DC, e.g. a receiver correspondingly adapted and the master evolved node B MeNB comprises means MeNB-RM for receiving information about DC support of said UE, e.g. a receiver correspondingly adapted, and means MeNB-PM for providing, to said UE, a connection reconfiguration message to change or split bearers from the MeNB to the SeNB, when said UE supports DC, e.g. a sender correspondingly adapted.

This application with embodiments may provide the following. Exchange of UE DC support capabilities and corresponding configuration of MeNB and UE for dual connectivity. Informing the serving node (MME) about the UE's dual connectivity support (e.g. during NAS exchange between the UE and MME, or during exchange between MME and HSS/HLR assuming that UE's DC capabilities are stored in the HSS/HLR). MME takes decision whether to include the UE's DC support capability to the RAN node (MeNB) considering e.g. the UE's established/available (current) EPS bearers, roaming/non-roaming status etc. MeNB configures the UE for radio measurements for small cell frequencies depending on the indication about DC support in the UE's context. Configuration in the MeNB for particular bearer redirection to SeNB. MeNB is configured with information (e.g. in the UE's bearer context) which bearers are allowed to be re-directed to SeNB and which not. This MeNB configuration is performed by the MME during any S1-AP procedure using “bearer marking” on per UE basis. MME has means to decide how to mark the bearers. MME-assisted bearer relocation to SeNB. Provisioning of the SeNB IP Address and DL TEID(s) from the SeNB to the MeNB so that the MeNB can utilize the Path Switch message to inform the MME/SGW of the new additional TEID(s), IP Address and EPS Bearer(s) that got relocated to the SeNB to the SGW to switch the path correctly. Access control in the MME for the UE to access the SeNB based on the SeNB identity, information exchange with HSS or UE subscription profile. UE-centric solution for bearer redirection to SeNB. UE is configured (e.g. by the serving node) which bearers are the admitted for relocation from MeNB to SeNB. If the UE detects coverage of small cell, during the radio measurement reporting to the MeNB (via RRC signalling) the UE additionally includes information about the bearer(s) which are admitted for relocation from MeNB to SeNB.

In an embodiment, UE Inter-Frequency Measurement. Based on the MME assistance to MeNB, it can configure inter-frequency periodicity of UEs, either completely suspending it, or requesting UEs to measure infrequently in order to save UE battery power. If measurement gaps need to be provided to the UEs, this mechanism would also save signaling to UE, apart from lowering power consumption.

This application may provide a method for bearer relocation from a macro cell to a small cell comprising the steps of: DC capability exchange between UE and MME, MME decides whether to modify/update the UE's context in MeNB for dual connectivity, MeNB instruction to the UE for measuring radio resources of small cells, Configuration for particular bearer redirection to SeNB by MME or OAM Server, SeNB informing the MeNB with a Relocation Complete message that the UE has changed cell including the SeNB IP Address and DL TEID(s), MeNB enhancing the Path Switch message with the SeNB IP Address, DL TEID(s) and EPS Bearer ID(s) towards the MME and the SGW for correct path switch at the SGW towards the SeNB, Admission control at the MME for the bearer relocation to SeNB.

This application with embodiments may provide inter alia the following advantages compared to conventional state-of-the-art methods and systems. This application e.g. enables bearer switch/re-direction from an MeNB to an SeNB for a DC capable UE in ECM-CONNECTED mode. The following the advantages are foreseen compared to the state-of-the-art. The proposed solution(s) according to this application allows to configure the UE for small cell measurements only if needed according to UE capability and the core network policy. The core network policy is used to perform the bearer marking to “allow” or “not allow” switch/re-direction of bearer(s) to small cell even in cases where the MeNB does not have the bearer information, e.g. bearer relationship to specific APN, home-routed or LBO traffic, etc.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for dual connectivity, ‘DC’, performed by a user equipment, ‘UE’, wherein said UE is in connected mode and is connected to a master evolved node B, ‘MeNB’, and connectable to a secondary evolved node B, ‘SeNB’,
the method comprising:
informing a communication system entity about DC support of said UE, and
when the UE supports DC, receiving a connection reconfiguration message to change or split bearers from the MeNB to the SeNB.

2. The method according to claim 1, wherein said connection reconfiguration message comprises a new radio resource configuration for DC with the SeNB.

3. The method according to claim 1, wherein said communication system entity is either the MeNB or a mobility management entity, ‘MME’.

4. A method for dual connectivity, ‘DC’, performed by a master evolved node B, ‘MeNB’, in a communication system including a user equipment, ‘UE’, wherein said UE is in connected mode and is connected to said MeNB and connectable to a secondary evolved node B, ‘SeNB’,
the method comprising:
receiving information about DC support of said UE; and
providing, to said UE, a connection reconfiguration message to change or split bearers from the MeNB to the SeNB, when said UE supports DC.

5. The method according to claim 4, wherein said MeNB decides to configure said UE for DC.

6. The method according to claim 5, wherein said decision is based on properties of current bearers of said UE.

7. The method according to claim 4, wherein said connection reconfiguration message comprises a new radio resource configuration for DC of said UE with said SeNB.

8. A method for dual connectivity, ‘DC’ performed in a communication system including a user equipment, ‘UE’, wherein said UE is in connected mode and is connected to a master evolved node B, ‘MeNB’, and connectable to a secondary evolved node B, ‘SeNB’,
the method comprising:
the UE:
informing a communication system entity about DC support of said UE, and
when said UE supports DC, receiving a connection reconfiguration message to change or split bearers from said MeNB to said SeNB.
the MeNB:
receiving information about DC support of said UE; and
providing, to said UE, a connection reconfiguration message to change or split bearers from said MeNB to said SeNB when said UE supports DC.

9. The method according to claim 8, wherein said MeNB decides to configure said UE for DC.

10. The method according to claim 9, wherein said decision is based on properties of current bearers of said UE.

11. The method according to claim 8, wherein said connection reconfiguration message comprises a new radio resource configuration for DC of said UE with said SeNB.

12. The method according to claim 8, further comprising:
the SeNB:
receiving bearer relocation information of said UE for changing or splitting bearers from said MeNB to said SeNB when said UE supports DC;
allocating radio resources for said bearers on said SeNB if available; and
receiving said bearers from said MeNB.

13. A method for dual connectivity, ‘DC’, of a user equipment, ‘UE’, including information of a communication system entity about DC support of said UE, wherein a connection reconfiguration message to change or split bearers from a master evolved node B, ‘MeNB’, to a secondary evolved node B, ‘SeNB’, is generated by said MeNB when the UE supports DC and sent to said UE.

14. The method according to claim 13, characterized in that said connection reconfiguration message is generated based on properties of current bearers of said UE.

15. The method according to claim 13, wherein said MeNB includes in said connection reconfiguration message a new radio resource configuration for said UE for DC of said UE with said SeNB.

16. The method according to claim 13, wherein the information about DC support is sent directly to said further communication system entity by said UE or via said MeNB.

17. The method according to claim 16, wherein said further communication system entity is provided in form of a mobility management entity, ‘MME’.

18. The method according to claim 13, wherein said MeNB maintains bearer relocation information of bearers of said UE for relocation to said SeNB.

19. The method according to claims 17 and 18, wherein said bearer relocation information is configured on said MeNB during a S1-MME procedure.

20. A user equipment, ‘UE’, wherein said UE is in connected mode and is connected to a master evolved node B, ‘MeNB’, and connectable to a secondary evolved node B, ‘SeNB’,
the UE comprising
means for informing a communication system entity about its dual connectivity, ‘DC’ support, and
means for receiving a connection reconfiguration message to change or split bearers from said MeNB to said SeNB when said UE supports DC.

21. A master evolved node B, ‘MeNB’, in a communication system including a user equipment, ‘UE’, wherein said UE is in connected mode and is connected to said MeNB, and connectable to a secondary evolved node B, ‘SeNB’,
the MeNB comprising:
means for receiving information about dual connectivity, ‘DC’ support of said UE; and
means for providing, to said UE, a connection reconfiguration message to change or split bearers from said MeNB to said SeNB, when said UE supports DC.

22. A communication system including a user equipment, ‘UE’, wherein said UE is in connected mode and is connected to a master evolved node B, ‘MeNB’, and connectable to a secondary evolved node B, ‘SeNB’,
the communication system comprising
the UE comprising
means for informing a communication system entity about its dual connectivity, ‘DC’ support, and
means for receiving a connection reconfiguration message to change or split bearers from said MeNB to said SeNB when said UE supports DC.
the MeNB comprising:
means for receiving information about DC support of said UE; and
means for providing, to said UE, a connection reconfiguration message to change or split bearers from said MeNB to said SeNB, when said UE support DC.
